(19) United States
(12) Patent Application Publication
(10) Pub. No.: US 2009/0087812 A1
(43) Pub. Date: Apr. 2, 2009

(54) SELF-CUSTOMIZABLE DENTAL TREATMENT TRAYS

(75) Inventor: Scot N. Andersen, Draper, UT (US)

Correspondence Address: Workman Nydegger;1000 Eagle Gate Tower, 60 East South Temple, Salt Lake City, UT, 84111, US

(73) Assignee: Ultradent Products, Inc., South Jordan, UT (US)

(21) Appl. No.: 11/865,867

(22) Filed: Oct. 2, 2007

(51) Int. Cl. A61C 9/00

(52) U.S. Cl. 433/37; 433/215

(57) ABSTRACT

A self-customizable dental tray usable in a dental application is prepared as follows: providing a barrier layer in the shape of a dental treatment tray having a wall thickness of less than or about 1 mm; introducing a curable elastomeric material onto an impression-receiving surface of the barrier layer; placing the barrier layer having the curable elastomeric material onto the teeth so that the curable elastomeric material forms an impression layer; and allowing the curable elastomeric material to cure so as to form an impression layer having a teeth-receiving surface with contours adapted to conform with the teeth, said impression layer having a wall thickness of less than or about 1 mm. Optionally, the barrier layer is a liner that can be separated from a support tray that provides a tray shape to the liner.

### BACKGROUND OF THE INVENTION

1. The Field of the Invention

The present invention relates generally to self-customizable dental treatment trays, kits for self-customizing the dental trays, and methods for self-customizing the dental trays to improve the retention and comfort of the dental tray within a mouth. More particularly, the invention relates to the use of an elastomeric material, such as a curable denture reline material, with a thin-walled barrier layer and/or liner to help customize the fit to the teeth and provide improved retention and comfort. The dental tray can be used for administering dental agents such as bleaching agents, fluoride, desensitizing agents, antimicrobial agents, anticariogenic agents, or other dental agents or medicines.

2. The Related Technology

Virtually all people desire white or whiter teeth. To achieve this goal, people either have veneers placed over their teeth or have their teeth chemically bleached. In the past, people who desired to have their teeth bleached had to submit to conventional in-office bleaching techniques. The process generally involves: (1) making an alginate impression of the patient's teeth; (2) making a stone cast or model of the impression; (3) vacuum forming a dental tray from the model, usually from a sheet of thin ethyl vinyl acetate (EVA) material, and trimming to exclude gingival coverage. This method results in a tray that is soft and flexible and that is very accurately customized to the patient's teeth. However, the method is time consuming and the resulting tray is relatively expensive.

Because of the high cost of producing custom dental trays, less costly alternatives have been developed. However, these alternatives have substantial disadvantages in terms of accuracy, effectiveness, and comfort of the finished custom tray.

One alternative is the so-called “boil and bite” tray. A relatively thick, non-custom preformed tray (similar to a mouth guard) made of EVA, polyethylene, or other material is submerged in boiling water. The preformed tray is relatively thick (e.g., >2 mm) to prevent the tray from collapsing on itself and becoming entirely unusable during the heating process. Upon removal from the heated water, the tray is quickly placed inside a user's mouth. The user bites down and applies contact pressure to make an impression of the biting surfaces of the user's teeth. One problem with “boil and bite” trays is that they are relatively thick and bulky, which make them more intrusive and less comfortable to wear compared to customized trays. The thickness of large, bulky preformed trays also limits the accuracy with which they can be made to conform to the user's teeth and/or gums and makes the trays more rigid.

To the extent that boil and bite trays are made with thinner walls, such trays can be extremely difficult to work with because they tend to shrivel and collapse outside extremely narrow windows of temperature and heating time. For example, if the trays are left in a hot water bath too long (i.e., for more than a few seconds) they can quickly become limp and lose their pre-form shape, making it difficult or impossible to conform the tray to the user's teeth.

An alternative to dental trays are strips of a flexible plastic material coated with a bleaching agent that can be applied to a user's teeth. Such strips are placed against the teeth by the user to cover the labial surface of the front 6 teeth and then folded back to cover a portion of the lingual surfaces. Such dental strips can be awkward to place correctly and tend to be easily dislodged. Frequent replacement and refitting of the strips is often required. In addition, they primarily treat only the front surfaces of the teeth and provide little or no treatment of the lingual surfaces of the tooth. Moreover, they provide little or no treatment of the margins between the teeth.

Another alternative is the dual tray assembly disclosed in U.S. Pat. No. 5,616,027 to Jacobs et al. The dual tray assembly is composed of an outer tray that supports or carries an inner tray made of a thermoplastic material comprising EVA. In use, the tray assembly is submerged in hot water to render the inner tray pliable and moldable, while the outer tray remains rigid. The heated assembly is then placed in a patient's mouth to cause the inner tray to take an impression of the patient's teeth. The inner tray results in a final tray that is generally thinner and more comfortable to wear compared to conventional “boil and bite” trays that are sufficiently thick such that they do not need a supporting carrier tray. Nevertheless, heating of the tray is still required, and the formed tray must typically be trimmed to yield the finished tray.

In view of the foregoing, there is an ongoing need to develop more comfortable fitting dental trays that can be easily placed over a person's teeth and that will remain in place during the desired treatment time. There is also a need to develop alternatives that are simpler to use but result in a comfortable-fitting tray in order to promote compliance with dental treatment regimes.

### BRIEF SUMMARY OF THE INVENTION

The present invention relates generally to the use of curable elastomeric materials to help affix and accurately contour thin-walled dental trays to teeth. The invention is generally compatible with any flexible, thin-walled, polymeric dental tray materials and any curable elastomeric materials. Conventional denture reline materials are preferred, and silicone-based denture reline materials are more preferred. The thin-walled dental tray material can be a non-custom dental tray that is later customized with the curable elastomer to fit the contours of teeth.

The present invention includes a self-customizable dental treatment tray that is usable in a dental treatment to treat teeth. Such a dental treatment tray includes an outer barrier layer having a customized impression layer disposed thereon. The barrier layer is comprised of a thin, flexible polymeric material and has a maximum wall thickness of less than about 1 mm. The barrier layer has an impression-receiving surface. The customized impression layer (e.g., cured elastomeric impression) is typically disposed adjacent to the impression-receiving surface of the barrier layer and has a maximum wall thickness of less than about 1 mm. The impression layer is comprised of an elastomer material that is cured in the mouth so as to form a teeth-receiving portion of the dental treatment tray that has contours adapted to conform with the shape of the teeth. In the case where the curable impression layer does not readily adhere to the polymeric barrier layer, an adhesive may be interposed between the barrier layer and impression layer.

According to one embodiment, the barrier layer may comprise a thin-walled, non-custom dental tray comprising a flexible polymer material. According to another embodiment, the barrier layer comprises a thin-walled, customized dental tray comprising a flexible polymer material. In such cases, the dental tray is able to maintain itself in the form a tray absent external support. As such, an intermediate device used to form the finished dental treatment tray may comprise a dental tray with uncured elastomeric impression material disposed adjacent to the dental tray.

According to yet another embodiment, the barrier layer comprises a thin, flexible membrane that is not capable of maintaining itself in the shape of a dental tray absent the customized impression layer, which contributes to the ability of the overall treatment tray composite to resiliently maintain itself in the shape of a tray. In this embodiment, an intermediate device comprising the flexible membrane layer and uncured elastomeric impression material may also include an exoskeleton support tray into which the membrane layer is placed which holds the barrier layer in the shape of a tray before formation of the customized impression layer. A weakly adhering temporary adhesive may be used to temporarily adhere the flexible membrane layer and exoskeleton support tray.

The polymer material of the thin, flexible barrier layer may comprise curable and/or thermoplastic materials. According to one embodiment, the polymer material is comprised of a curable elastomer, an example of which is silicone. According to another embodiment, the polymer tray material is a thermoplastic material, examples of which include thermoplastic elastomers and materials that are not elastomeric.

The dental treatment tray is designed to be thin-walled, flexible and highly comfortable, as opposed to bulky trays that have a shape and dimension sufficient to function as a protective mouth guard that protects the teeth during athletic events. That is, the dental treatment tray does not have sufficient properties to protect the teeth from an impact that may occur during an athletic event, and thereby cannot function as a protective mouth guard, but rather increases comfort and reduces intrusiveness. To achieve this result, the dental treatment tray will have an overall wall thickness less than 2 mm, preferably less than about 1.75 mm, more preferably less than about 1.5 mm, even more preferably less than about 1.25 mm, and most preferably less than about 1 mm.

In one embodiment, the customized impression layer can be prepared by placing a curable elastomeric material onto the impression-receiving surface of the barrier layer and curing said curable elastomeric material so as to form the teeth-receiving portion of the dental treatment tray. As such, the curable elastomeric material can be initially flowable when placed onto the impression-receiving surface.

In one embodiment, the curable elastomeric material and/or the elastomeric impression layer, liner layer, and/or barrier layer can be made of at least one silicone-based polymer.

According to one embodiment, at least one of the barrier tray, liner, or impression layer has a maximum wall thickness of less than about 1 mm, preferably less than about 0.85 mm, more preferably less than about 0.75 mm, even more preferably less than about 0.65 mm, and most preferably less than about 0.5 mm.

In some instances, the maximum wall thickness of the impression layer is an average wall thickness. In other instances, the maximum wall thickness is measured at the thinnest point of the impression layer at a tooth contouring surface because teeth contours can have shapes that cause the wall to be thinner at some points compared to others. For example, the impression layer can have a thinner wall proximate a tooth surface compared to a position proximate to a junction between adjacent teeth.

In one embodiment, at least one of the barrier tray, liner, or impression layer has a durometer value between about 40 and about 80, more preferably between about 50 and about 70, and most preferably between about 55 and about 65. Also, the combination of the barrier tray and impression layer or liner and impression layer has a durometer value less than about 100, more preferably between about 80 and about 90, and most preferably about 85. In general, thicker walled dental trays have lower durometer values to provide flexibility and comfort. Thinner walled dental trays may have higher durometer values to help maintain the shape of a tray while still providing flexibility and comfort owing to their decreased thickness.

The present invention includes a method for making a self-customizable dental treatment tray that is usable in a dental treatment to treat teeth. Such a method can include the following: providing a flexible barrier layer having a maximum wall thickness of less than about 1 mm and having an impression-receiving surface; placing a quantity of a curable elastomeric material onto the impression-receiving surface; placing the barrier layer having the curable elastomeric material over the teeth in a manner so that the curable elastomeric material forms an impression of at least a portion of the teeth; and allowing the curable elastomeric material to at least partially cure so as to form an impression layer having a teeth-receiving surface with contours adapted to conform with the shape of teeth, the impression layer having a maximum wall thickness of less than about 1 mm. In the case where a support tray is used, the support tray may be removed after placing the barrier layer and curable elastomeric material over the teeth, preferably after the elastomeric material has at least partially cured.

In one embodiment, the method can include removing the dental treatment tray, and curing the impression layer outside the mouth after the curable elastomeric material has formed the impression but before being fully cured. As such, the curable elastomeric material can continue curing outside the mouth.

In one embodiment, the method can include applying an adhesive layer onto the impression-receiving surface of the barrier layer before applying the curable elastomeric material onto the impression-receiving surface so that the adhesive layer is disposed between the impression-receiving surface and the impression layer.

In one embodiment, the method can include preparing the curable elastomeric material from multiple compositions that include at least one pre-elastomeric composition and a curing agent.

In one embodiment, the present invention includes a kit for use in preparing a self-customizable dental treatment tray that is usable in a dental treatment to treat teeth. Such a kit can include the following: a thin, flexible barrier layer having a maximum wall thickness of less than about 1 mm and having an impression-receiving surface; and at least one curable elastomeric material that is to be placed onto the impression-receiving surface so as to form a customized impression layer that is disposed on the impression-receiving surface of the barrier layer and that has contours adapted to conform with the shape of teeth. Optionally, the kit can also include an adhesive that is configured to be disposed between the barrier layer and the impression layer so as to form an adhesive layer. The components of the kit can be configured as described herein.

In the case where the barrier layer is a flexible membrane material, the kit may also include one or more exoskeleton support trays. A temporary adhesive material used to temporarily adhere the a flexible membrane material to the exoskeleton support tray may be included.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an embodiment of a dental treatment tray configured to fit over at least a portion of an upper or lower dental arch;

FIG. 2 is a perspective view of an embodiment of a dental treatment tray configured to fit over at least a portion of an upper or lower dental arch.

FIG. 3 is a perspective view of an embodiment of a dental treatment tray configured to fit over at least a portion of an upper or lower dental arch;

FIG. 4A is a cross sectional view of an embodiment of a dental treatment tray having an unformed curable elastomer;

FIG. 4B is a cross sectional view of an embodiment of a dental treatment tray having a formed curable elastomer that conforms with the shape of teeth;

FIG. 5A is a cross sectional view of an embodiment of a dental treatment tray having an adhesive and an unformed curable elastomer;

FIG. 5B is a cross sectional view of an embodiment of a dental treatment tray having an adhesive and a formed curable elastomer that conforms with the shape of teeth;

FIG. 6A is a close up cross sectional view of an embodiment of a dental o treatment tray placed over a dental arch showing how the V-shaped indentation in the bottom wall is configured for insertion into the depression of a molar;

FIG. 6B is a close up cross sectional view of an embodiment of a dental treatment tray placed over a dental arch showing how the curvature of the front side wall and bottom wall account for flaring of an incisor; and

FIGS. 7A-7B illustrate embodiments of kits that include an embodiment of a dental treatment tray contained within a sealed protective package, and optionally additional components of the kit.

### DETAILED DESCRIPTION OF THE PREFERRED EMBODIMENTS

The present invention relates to self-customized dental treatment trays, kits for preparing self-customized dental treatment trays, and methods for preparing and using self-customized dental treatment trays. Such customized dental treatment trays can be used in a dental procedure for treating teeth. The customized dental treatment trays of the present invention can provide a better and more accurate fit against teeth compared to conventional treatment trays, and thereby provide superior dental treatments.

Conventional dental trays come in a variety of shapes and designs. A customized dental treatment tray of the present invention is not limited to any particular design, so long as it contains at least one tooth or jaw-contacting surface that can include a customizable impression material that can be cured to conform with teeth. The dental trays and tray components described herein are not intended to limit the invention, but are presented simply to assist in describing the invention.

The customized dental treatment trays of the present invention can be prepared by various methods that include the use of a curable elastomeric material, which is placed on a barrier tray or flexible membrane liner and then inserted into the mouth in order to make an impression of at least a portion of the teeth. Upon curing, the resulting dental treatment tray is customized to accurately fit on and conform to the teeth. Such customization assists in retaining the dental treatment tray on the teeth, which increases the effectiveness of a dental treatment.

### I. Dental Treatment Tray

In one embodiment, the present invention includes a self-customizable dental treatment tray that is usable in a dental treatment to treat teeth of a patient. Such a dental treatment tray includes a barrier layer having a customized impression layer disposed thereon. The barrier layer is comprised of a flexible polymeric material and has a wall thickness of less than about 1 mm. Typically, a barrier layer can be in the form of a shaped tray or a membrane liner, and has an impression-receiving surface. The customized impression layer is disposed on the impression-receiving surface of the barrier layer, and has a wall thickness of less than about 1 mm. The impression layer is comprised of an elastomer that is cured in the mouth of the patient so as to form a teeth-receiving portion of the impression layer that has contours adapted to conform with the shape of the teeth of the patient.

In one embodiment, the barrier layer can be a non-custom barrier tray, a thermally-deformable barrier tray, a custom-fitted barrier tray, or a membrane liner initially disposed within an exoskeleton support tray. In the instance of a non-custom barrier layer, the impression layer provides customization in that the impression layer is adapted and cured to conform with the contours of the teeth of the patient. In the instance of thermally-deformable barrier trays and custom-fitted barrier trays, the impression layer can increase the customization provided by such trays and increase the conformability of the dental tray with the teeth of the patient. As such, the impression layer forms so as to have contours and shapes that substantially match the dentition so that the dental tray has an accurate and secure fit with respect to the teeth. While some barrier trays can have some contouring or customization, the additional use of the customizable impression layer can increase the custom fit. Thus, the impression layer increases the likelihood that the dental tray will precisely match the person's unique dentition.

Also, the barrier layer and impression layer are sufficient flexible, adaptable, and resilient so as to fit comfortably within the mouth of the patient. These features are beneficial in that they can increase the compliance of a patient with regard to the dental procedure. In instances that dental trays are uncomfortable, patients may tend to forego the dental procedure and may wear the dental tray for an insufficient amount of time. By being flexible, it is meant that the barrier tray, liner, and/or impression layer can be manipulated by hand or by mouth in a manner that allows for the body of the barrier tray, liner, and/or impression layer to bend, deform, and contour to the teeth, cheeks, lips, gums, tongue, or other part of the mouth. By being adaptable, it is meant that the barrier tray, liner, and/or impression layer can be made to be suitable to or fit a specific patient's mouth with comfort. By being resilient, it is meant that the barrier tray, liner, and/or impression layer can be compressed at specific locations relative to the teeth and gums as well as at locations between the top and bottom teeth so that there is some malleability in order to allow movement of the jaw, tongue, and the like.

In one embodiment, the exoskeleton support tray has substantially more rigidity than the membrane liner, and thereby provides support to the liner. In this instance, the liner is not sufficiently rigid so as to maintain itself in the form of tray before and during formation of the impression layer. The support tray therefore holds the liner in shape until the impression layer is sufficiently formed so that the impression tray can then provide structural support to the membrane liner. In this embodiment, the impression layer has more rigidity than the liner, and thereby provides support to the liner in the absence of the support tray.

The balance of flexibility and rigidity can be characterized as a shape memory material. That is, the barrier tray has an original shape as described herein, which can be bent or deformed and then return to the original shape. This feature allows for enhanced customization by allowing the barrier to bend while being fitted onto the teeth, then attempt to return to the original shape and thereby increase the customized fit so that the impression layer and teeth have an increased contact surface area. Additionally, the impression layer can have an original shape after being cured.

In one embodiment, the impression-receiving surface of the barrier tray or liner can be substantially devoid of contours adapted to conform with the shape of the teeth of the patent. However, the impression-receiving surface can have at least some contours that adapt to conform with the shape of the teeth. In any event, the impression-receiving surface is shaped or otherwise configured so as to receive the curable impression material, which cures into an impression layer that has a customized fit with at least a portion of the teeth or all of the teeth. In order to provide a suitable impression-receiving surface for receiving the impression layer, a portion of the barrier tray can be substantially U-shaped, L-shaped, V-shaped, W-shaped (e.g., at the molars), or combination thereof, or the like. Also, other shapes can be employed that provide a surface configured to receive and retain the curable impression tray.

In one embodiment, the dental tray can have a shape and dimension configured so as to cover at least a portion of upper and/or lower teeth of the patient. In some instances, the dental tray can cover at least substantially the entire upper and/or lower teeth. Such shaping and dimensioning can include the dental tray having upper and/or lower troughs that are shaped and dimensioned to conform with the teeth and gums of the patient, and can allow for the impression layer to be applied over all or only a portion of the barrier tray and/or liner that contacts the teeth and optionally a portion of the gums. The dental tray may be shaped so as to overlap both the frontal and lingual surfaces of the teeth, or may be shaped so as to only overlap the frontal surfaces of the teeth. Also, the dental tray can be formed with upper and lower channels rather than a single channel. Accordingly, the upper and/or lower sections can include the impression-receiving surface as described above.

In one embodiment, the dental treatment tray is substantially devoid of a shape and dimension sufficient to function as a protective mouth guard that protects the teeth during athletic events. That is, the dental treatment tray does not have sufficient properties to protect the teeth from an impact that may occur during an athletic event, and thereby cannot function as a protective mouth guard. Typically, mouth guards have outer walls that can be compressed to protect teeth from an impact and will have a wall thickness of 3-5 mm. Thus, the present invention does not achieve this wall thickness range, and thereby the dental treatment tray is insufficient to function as a mouth guard and is incapable of protecting teeth from an impact. It is, however, more comfortable to wear compared to a sports mouth guard precisely because it is thin-walled and flexible

In one embodiment, a customized impression layer can be prepared by placing a curable elastomeric material onto the impression-receiving surface of the barrier layer and curing said curable elastomeric material so as to form the teeth-receiving portion of the dental treatment tray. As such, the curable elastomeric material can be initially flowable when placed onto the impression-receiving surface.

In one embodiment, the dental treatment tray includes an adhesive layer disposed between the barrier layer and the cured impression layer. The adhesive can be a substantially permanent adhesive that does not allow the layers to separate from each other. The adhesive layer has a maximum thickness dimensioned such that the maximum thickness of the dental treatment tray is less than 2 mm.

In one embodiment, at least one of the barrier layer or impression layer has a wall thickness of less than about 1 mm, preferably less than about 0.85 mm, more preferably less than about 0.75 mm, even more preferably less than about 0.65 mm, and most preferably less than about 0.5 mm. Usually, the barrier layer has a substantially uniform thickness; however, some variations in thicknesses at different locations are permissible. As such, the wall thickness can be an average wall thickness, maximum wall thickness, or the like.

In some instances, the wall thickness of the impression layer is an average wall thickness or maximum wall thickness. In other instances, the wall thickness is measured at the thinnest point of the impression layer at a tooth contouring surface because teeth contours can have shapes that cause the wall to be thinner at some points compared to others. For example, the impression layer can have a thinner wall proximate a tooth surface compared to a position proximate to a junction between adjacent teeth.

In one embodiment, the dental treatment tray has an overall wall thickness of less than 2 mm, preferably less than about 1.75 mm, more preferably less than about 1.5 mm, even more preferably less than about 1.25 mm, and most preferably less than about 1 mm.

In one embodiment, at least one of the barrier tray, liner, and/or impression layer has a durometer value between about 40 and about 80, more preferably between about 50 and about 70, and most preferably between about 55 and about 65. Also, the combination of the barrier tray and impression layer or liner and impression layer has a durometer value less than about 100, more preferably between about 80 and about 90, and most preferably about 85. In general, thicker walled dental trays have lower durometer values to provide flexibility and comfort. Thinner walled dental trays may have higher durometer values to help maintain the shape of a tray while still providing flexibility and comfort owing to their decreased thickness.

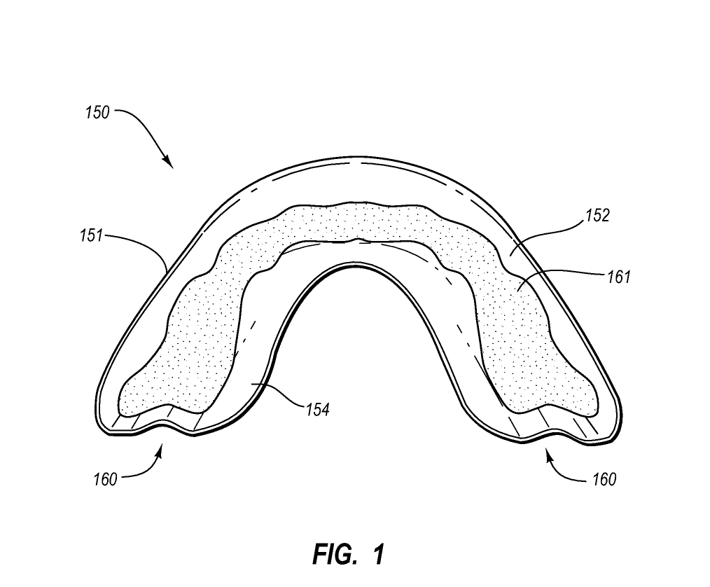

FIG. 1 illustrates an embodiment of a dental treatment tray 150. The dental treatment tray 150 is shown to include barrier tray 151 that is sized and configured for placement over a dental arch. The barrier tray 151 includes a side wall 152 and a bottom wall 154 that cooperate to form an L-shaped cross-sectional profile. The bottom wall 154 is shown to include V-shaped indentations 160 configured to be inserted into the depression typically found along the occlusal surfaces of left and right molars. In the illustrated embodiment, the barrier tray 151 includes a gelatinous composition 161 disposed thereon. The gelatinous composition 161 is the curable elastomer that forms the impression layer.

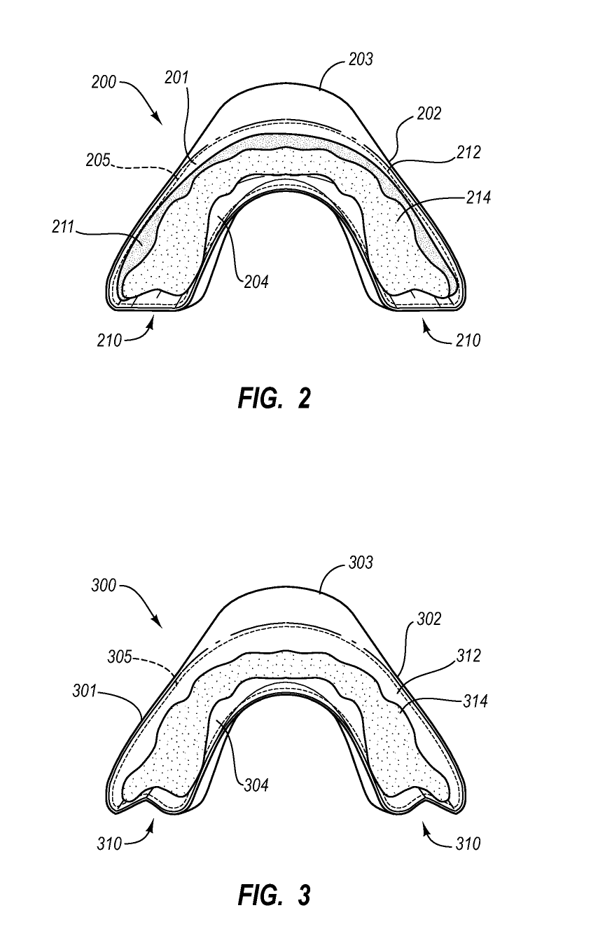

FIG. 2 illustrates another embodiment of dental treatment tray 200. The dental treatment tray 200 includes an exoskeleton support tray 201 that has a handle 203. Disposed on the support tray 201 is a barrier layer in the form of a membrane liner 205 as described herein. The liner 205 is represented by the dashed lines, and has the shape provided by the support tray 201. The support tray 201 is configured to be peeled from the liner 205 after an impression layer (not shown) is formed, and prior to the liner 205 and impression layer being used as a dental treatment tray 200.

The liner 205 includes an impression-receiving surface 212 having a shape that is at least partially defined by a side wall 202 and a bottom wall 204 of the support tray 201. The liner 205 is shown to include a substantially solid adhesive composition 211 covering at least a portion of the impression-receiving surface 212. The molar region 210 of the dental treatment tray 200 is shown to have a substantially flat bottom wall 204 that intersects the side wall 212 so as to form a U-shaped cross-sectional profile.

Additionally, the liner 205 is shown to include a curable elastomer 214 disposed on the adhesive 211 and impression-receiving surface 212. This allows the curable elastomer 214 to directly contact a person's teeth and form an impression layer having an impression of the teeth. Also, the adhesive 211 facilitates bonding of the curable elastomer 214 to the liner 205. The adhesive 211 is especially beneficial in instances the liner 205 is comprised of a material that is not sufficiently adherent to the cured elastomer 214 of the impression layer. Optionally, a peelable adhesive can be disposed between the support tray 201 and the liner 205.

FIG. 3 illustrates an embodiment of a dental treatment tray 300 that includes a exoskeleton support tray 301 having an optional handle 303. The support tray 301 has a shape substantially defined by a side wall 202 and a base wall 104. The support tray 301 is flexibly rigid so as to have an original shape and a body that can be flexed and automatically return to the original shape.

The support tray 301 includes a barrier liner 305, which is represented by the dashed lines. The liner 305 is flimsy and flexible and is held into the shape of a try by the support tray 301. Without structural support, the flimsy liner 305 does not hold any particular shape. The support tray 301 and liner 305 are configured to be peeled from each other before the liner 305 and impression layer (not shown) is used as a dental treatment tray 300. However, the support tray 301 can be used to provide a tray shape to the liner during formation of an impression layer.

Additionally, the liner 305 includes an impression-receiving surface 312 having a shape that is at least partially defined by the side wall 302 and bottom wall 304 of the support tray 201. A curable elastomer 314 is shown to be disposed on the impression-receiving surface 312 such that the curable elastomer 314 directly contacts a person's teeth when the impression layer is being formed. The impression layer allows the dental treatment tray 301 to have a custom fit for a person's teeth when the dental treatment tray 300 is in use.

Also, the V-shaped indentations 310 along with the side wall 302 and bottom wall 304 can form a W-shaped cross-sectional profile at the molar region. This shape provides enhanced contact with the indentations of the molars.

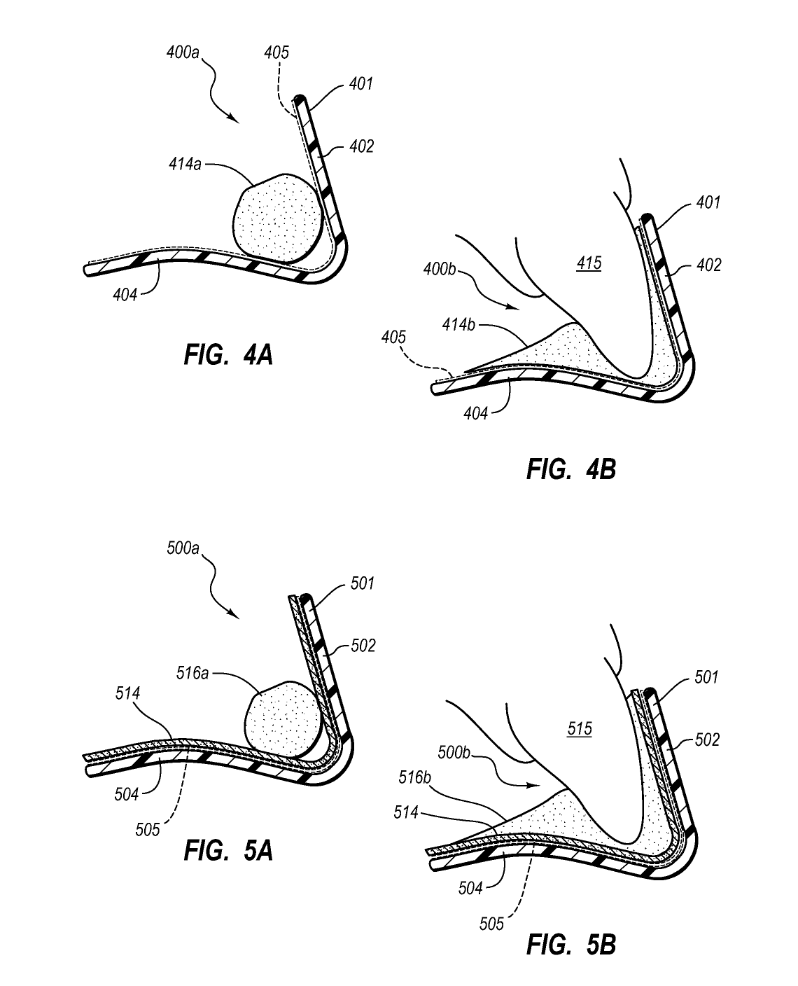

FIGS. 4A-4B illustrate a cross section of an embodiment of a dental treatment tray 400a-400b. FIG. 4A illustrates a cross section of a dental treatment tray 400a having a barrier tray 401 that includes a side wall 402 and a bottom wall 404. A curable elastomer 414a is disposed adjacent to both the side wall 402 and the bottom wall 404. As shown in FIG. 4A, the curable elastomer 414a is in an unformed shape prior to being in contact with teeth 415. FIG. 4B illustrates a cross section of a dental treatment tray 400b after the barrier tray 401 having the curable elastomer 414b has been applied to the teeth 415 so that the curable elastomer 414b is shaped so as to conform with the shape of the teeth 415. As such, the curable elastomer 414b forms an impression layer. Additionally, an optional adhesive layer 405 is shown to be disposed between the barrier tray 401 and the elastomer 414a-b.

FIGS. 5A-5B illustrate a cross section an embodiment of a dental treatment tray 500a-500b. FIG. 5A illustrates a cross section of a dental treatment tray 500a having a support tray 501 that includes a side wall 502 and a bottom wall 504. A liner 514 is shown to be disposed on the side wall 502 and bottom wall 504. A curable elastomer 516a-b is disposed on the liner 514 adjacent to both the side wall 502 and the bottom wall 504. As shown in FIG. 5A, the curable elastomer 516a is in an unformed shape prior to being in contact with teeth 515. FIG. 5B illustrates a cross section of a dental treatment tray 500b after the support tray 501 and liner 514 having the curable elastomer 516b has been applied to the teeth so that the curable elastomer 516b is shaped so as to conform with the shape of the teeth 515 and form an impression layer. Additionally, an optional peelable adhesive layer 505 is shown to be disposed between the support tray 501 and the liner 514.

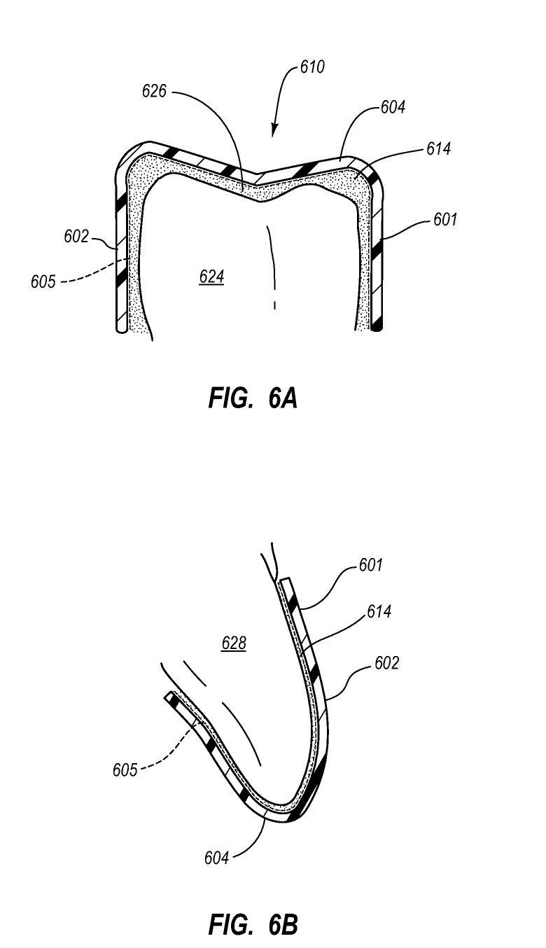

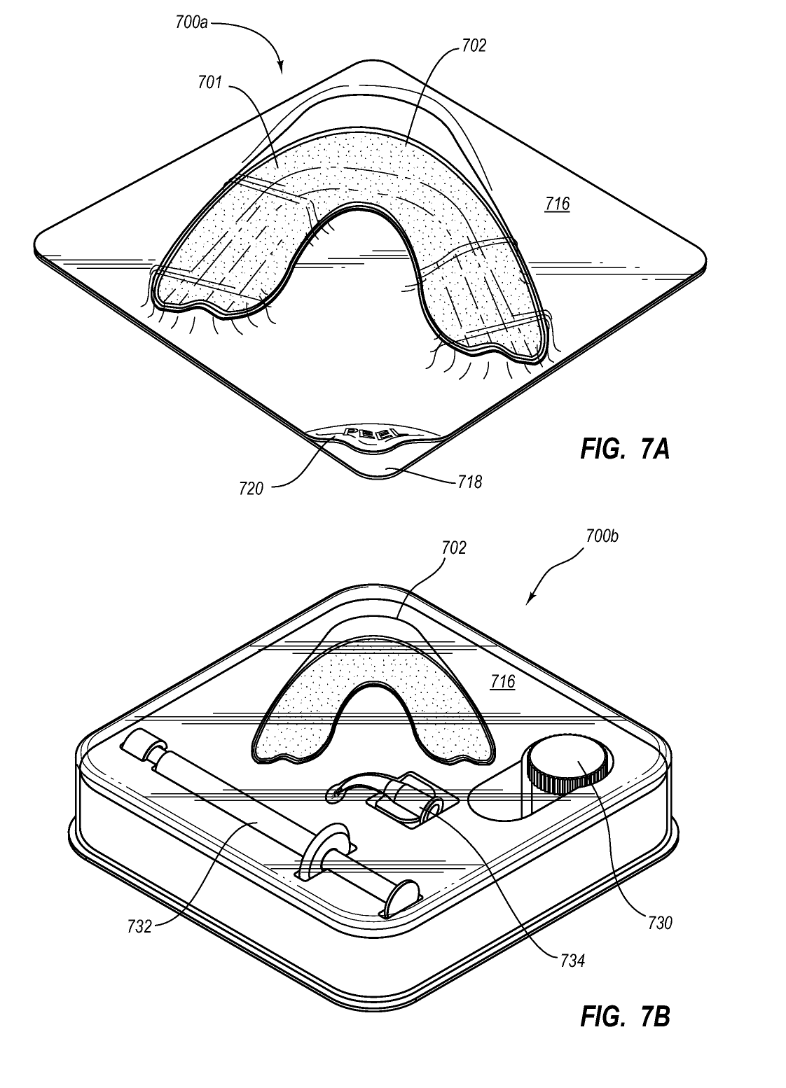

FIG. 6A is a close up cross-sectional view illustrating how a V-shaped indentation 610 in the bottom wall 604 of a barrier layer 601 is configured for insertion into the depression in a molar 624. As seen, the molar 624 includes a depression 626 into which the V-shaped indentation 610 of the barrier layer 601 is configured to be inserted. Additionally, an elastomer impression layer 614 is disposed between the molar 624 and the barrier layer 601, and substantially fills the void between the molar 624 and the barrier layer 601. This can also include the side wall 602 having the elastomer impression layer 614 disposed thereon so as to fill the void between molar 624 and the side of the barrier layer 601. The elastomer impression layer 614 provides better conformity between the barrier layer 601 and the molar 624.

However, the barrier layer 601 can be devoid of the indentations 610. While the bottom wall 604 of the barrier layer 601 may have a tendency to span the molar 624 like a bridge between the generally higher outer edges, thereby leaving a gap between the bottom wall 604 and the surface of the molar 624 between the outer edges, the elastomer impression layer 614 can fill such a gap. As such, the elastomer impression layer 614 can prevent dislodgement of the barrier layer 601 when the upper and lower molars 624 are brought together. For example, the elastomer impression layer 614 prevents the bottom wall 604 from being pushed into the molar depression 626 by the opposing molars 624.

FIG. 6B is a close up cross-sectional view illustrating how the elastomer impression layer 614 conforms with the teeth and curvature of the side wall 602 and bottom wall 604 account for flaring of incisors 628. A typical person's incisors 628 are not vertical, and typically flare outwards slightly. The side wall 602 and bottom wall 604 may have different radii in order to compensate for the general flaring out of a person's incisors 628 toward the incisal edges. Due to such flaring the diameter of a person's dental arch at the incisal edges is generally greater than the diameter at the gingival margin. Thus, the elastomer impression layer 614 helps provide for a better fit of the barrier layer 601 over a person's incisors 628

Additionally, FIGS. 6A-6B illustrate an instance where the barrier layer 601 is an exoskeleton support tray that includes a liner 605 (shown by the dashed lines) disposed thereon. As shown, the barrier layer 601 provides a tray shape to the liner 605 so that the barrier layer 601 can be removed from the liner 605 after the impression layer 614 is cured so as to provide structural support to the liner 605. The liner 605 having the impression layer 614 can then be used as a dental treatment tray 610.

### II. Dental Tray Compositions

The dental treatment trays and individual components are usually fabricated from special medical grade rubber, polyurethane, vinyl, silicone materials, or the like. Such materials are biocompatible and can be placed in contact with human tissues without inducing an adverse immunological response. Also, the materials are suitable for providing a dental treatment and can be resistant to the chemicals that are utilized during such chemical treatments. Thus, the dental treatment trays can be prepared from a wide variety of materials that are commonly employed in dental applications.

In one embodiment, materials that can be used to form the barrier member (e.g., barrier tray and/or barrier liner) include cured elastomers (e.g., elastomeric polymers and natural or synthetic rubbers). Elastomers are characterized by resisting deformation by force and automatically recovering to substantially the original shape after being deformed by the force. As such, elastomers behave similar to natural or synthetic rubbers. For example, some elastomers can be stretched repeatedly up to twice their original length (or more) and, immediately upon release of the stress, return with force to their approximate original length. Generally, the barrier tray is set to have a tray shape, while the barrier liner is flimsy and takes the shape provided by the barrier tray.

Examples of elastomers include natural rubbers, polyisoprenes, butyl rubbers, isobutylene and isoprene co-polymers, halogentated butyl rubbers, chlorobutyl rubbers, bromobutyl rubbers, polybutadienes, polystyrene and polybutadiene copolymers, nitrile rubbers, hydrated nitrile rubbers polybutadiene and acrylonitrile copolymers, chloroprene rubbers, polychloroprene, neoprene, saturated rubbers, ethylene propylene rubbers, polyethylene and polypropylene copolymers, ethylene propylene diene rubbers, epichlorohydrine rubbers, polyacrylic rubbers, silicone rubbers, fluorosilicone rubbers, perfluoroelastomers, polyether block amides, tetrafluoro ethylene/propylene rubbers, chlorosulfonated polyethelenes, ethylene-vinyl acetates, thermoplastic elastomers, thermoplastic vulcanizates, polyurethane rubbers, polysulfide rubbers, silicones, polyorganosiloxanes, combinations thereof, and the like.

In one embodiment, it can be preferred for the elastomer to be comprised of a silicone. Silicone materials are generally more compressible and, consequently, softer. At body temperature, silicones are shape-retaining, tough, flexible, and resilient. On the other hand, silicones can also be configured to be flimsy, but shape-retaining. Also, silicones are preferred because they tend to be relatively stable in the oral cavity. Examples of silicones include homopolymers and copolymers that contain at least one siloxane selected from dimethylsiloxanes, methylphenylsiloxanes, methylvinylsiloxanes, methylfluoroalkylsiloxanes, methylethylidenenorbomenesiloxanes, and the like. As such, examples of silicones include polyorganosiloxanes, polydimethylsiloxanes, polymethylphenylsiloxanes, polydialkylsiloxanes, polymethylvinylsiloxanes, polymethylfluoroalkylsiloxanes, polymethylethylidenenorbomenesiloxanes, and the like.

Additionally, the barrier layer (e.g., membrane liner) can be comprised a variety of other materials that are commonly employed in dental applications. Examples of such materials include polyolefins, ethylene-vinyl acetate copolymer (EVA), ethylene-vinyl alcohol copolymer (EVAL), polycaprolactone (PCL), polyvinyl chloride (PVC), polyesters, polycarbonates, polyamides, polyurethanes, polyesteramides, cellulosic ethers, ethyl cellulose, propyl cellulose, isopropyl cellulose, butyl cellulose, t-butyl cellulose, cellulose acetate, polyvinyl acetate, polyvinyl alcohol, shellac, chemical or light-cure materials (e.g., methacrylate or acrylate resins), combinations thereof, and the like. Examples of suitable polyolefins that can be used to make the base tray include polyethylene (PE), high density polyethylene (HDPE), low density polyethylene (LDPE), ultra low density polyethylene (ULDPE), polypropylene (PP), and polytetrafluoroethylene (PTFE) (e.g., TEFLON). An example of a suitable polyester for use in making the barrier tray includes polyethylene terephthalate (PET). Also, these materials can be used for the exoskeleton support tray or barrier tray.

In one embodiment, the impression layer is prepared from any of the curable materials that can be used to prepare the barrier layer. That is, any of the materials described for use in the barrier layer that can be prepared into a curable composition that can be cured so as to conform with the teeth can be employed as the curable impression material.

In one embodiment, the impression layer is prepared from a curable elastomeric material that is cured while in contact with the teeth so that the treatment tray more closely conforms to the lingual, buccal, and interproximal regions. As such, any of the elastomers described herein that can be prepared into a curable composition to be cured within a mouth may be used to prepare the impression layer.

In one embodiment, the curable impression material is prepared from a denture relining material. Curable denture relining materials can provide permanent resiliency, high dimensional stability, adequate adhesion to the barrier tray or liner, adequate wetability in the oral environment, and compatibility with oral tissue by being non-toxic, non-irritant, and resistant to bacterial growth. Examples of suitable denture reline materials include silicone-based reline materials include, such as the following: UFI GEL SC (VOVO GmbH, Cuxhaven, Germany); GC RELINE SOFT and GC RELINE EXTRA SOFT (GC America, Inc., Alsip, Ill.); MOLLOSIL PLUS and MOLLOPLAST-B (Hydro-Cast Dental Products, Kansas City, Mo.); NOVUS (The Hygenic Group); LYNAL (L.D. Caulk/Dentsply); and VISCO-GE (Ash/Dentsply). Other reline materials include such materials as a (meth)acrylic acid ester polymer, a fluorine-contained resin, a polyolefin type resin, a silicone rubber, the materials disclosed by U.S. Pat. No. 5,952,400 (incorporated herein by reference) and the like. Additionally, any silicone material that can be prepared into a curable composition for at least partially curing in a mouth can be used as the curable impression layer in accordance with the present invention.

In one embodiment, the curable impression material is comprised of a vinyl-terminated siloxane polymer. Vinyl-terminated siloxane polymer mixes are typically heat cured, and can contain an amount of benzoyl peroxide, which acts as a free-radical polymerization and cross-linking initiator. Upon application of heat, the initiator promotes the cross linking of the polymer molecules, and thus converts the linear polymer into a highly resilient elastomer. The heat activated cross-linking reaction is in the nature of a pure addition reaction which does not produce any by-product.

In one embodiment, the curable impression material is comprised of a hydroxyl-terminated polydimethylsiloxane. Hydroxyl-terminated polydimethylsiloxanes are usually cured through a condensation reaction. Although a condensation reaction does not require heat, the reaction requires a cross-linking agent, such as tetraethyl silicate, and a catalyst, such as dibutyl tin dilaurate. Upon mixing the polysiloxane, cross-linking agent, and the catalyst, the catalyst initiates the cross linking of the polysiloxane molecules at room temperature and converts the linear polymer into a highly resilient elastomer.

In one embodiment, the curable elastomeric material is formed from a multi-part composition (e.g., a two-part composition) comprising at least one curable resin (e.g., siloxane monomer, oligomer, or polymer) and at least one chemical curing agent that causes the curable resin to polymerize and/or cross link so as to form a somewhat more rigid material that forms into the dental impression.

In one embodiment, the cured elastomeric material that forms the impression layer preferably remains sufficiently resilient in order to allow the impression layer to be applied to and/or removed from teeth without damaging the impression or causing discomfort to the person. However, due to the dimension of the impression layer, the structural characteristics of the barrier tray may provide sufficient support to the impression layer to enable manipulation during the dental application. In this way, the cured impression layer provides a custom shape that conforms to the teeth, while the barrier tray provides greater durability and resistance to breakage compared to the cured impression layer. Alternatively, the impression layer can provide sufficient support to the membrane liner, as described herein. Thus, the two different materials provide a synergistic effect that takes advantage of the different properties of the barrier layer on the one hand, and the cured impression layer on the other.

In one embodiment, the adhesive is a polymeric adhesive. Examples of adhesives include acrylics, polyisobutylenes, silicones, and the like. Dental adhesives are well known in the art.

In one embodiment, the elastomer is cured by free-radical polymerization, which requires an initiator to generate a free-radical. Various types of initiators produce a free-radical upon being exposed to light, heat, or chemicals. The initiator compounds are provided into the elastomer in an effective amount to initiate polymerization or enhance the rate of curing.

Photo-initiators are a group of compounds that will generate a free radical when exposed to light having a specific wavelength. As such, different photo-initiators are selected depending on the wavelength of light that will initiate the polymerization. Examples of photo-initiators include benzophenone, benzoin, 9,10-phenanthrenequinone, diacetyl, furil, anisil, 4,4′-dichlorobenzil, 4,4′-dialkoxybenzil, phenylpropanedione, acylphosphine oxides, camphorquinone, derivatives thereof, and the like. Photopolymerization can be initiated, for example, by irradiation with light having a wavelength of from about 400 nm to about 500 nm.

Heat-initiators can also be used. Examples of heat-initiators include t-butyl peroxide, dibenzoyl peroxide, dilauroyl peroxide, t-butyl peroctoate, t-butyl perbenzoate, and the like. Typically, heat-initiators are used when a majority of the curing occurs outside the mouth.

On the other hand, in certain applications a chemical-initiator, which typically is comprised of at least two co-initiators that generate a free radical, is preferred to induce polymerization. Additionally, a chemical-initiator can be used as a co-initiator. These chemical-initiator systems use a reactive pair, for example, benzoyl peroxide, lauryol peroxide, or dibenzoyl peroxide, in combination with an N,N-dimethyl-p-toluidine, N,N-dihydroxyethyl-p-toluidine, and other similar amines. Alternatively, a combined system including a photo-initiator, heat-initiator, and/or chemical-initiator can be used. Additionally, other curing agents, which are well known in the art, can be used to cure the elastomer.

In one embodiment, the composition of the exoskeleton support tray and the liner is non-adherent with respect to each other or have a peelable adherence. This allows the curable elastomer to be placed into the liner and molded to the teeth to cure into an impression layer conforms with the teeth and barrier tray. After the impression layer is cured, the liner having the impression layer can then be separated from the support tray and utilized as a treatment tray. In this embodiment, the cured elastomer can include the properties described above with respect to a barrier tray as described herein. That is, the cured elastomer can have sufficient flexibility, adaptability, and/or compressibility so as fit comfortably within the mouth of the patient and be utilized to provide structural support to the liner.

### III. Method of Manufacture

In one embodiment, the present invention provides a method for preparing a self-customizable dental tray to fit securely and comfortably to one or more teeth within a mouth. Such a method includes first providing a thin-walled barrier layer (e.g., barrier tray and/or barrier liner) having an impression-receiving portion with a thickness less than about 1 mm, and which is adapted to contact the occlusal surface of at least one tooth. Next, a curable elastomeric material, such as a silicone, is introduced onto the impression-receiving surface of the barrier layer, such as by applying it into a trough associated with the impression-receiving portion of the barrier layer. Optionally, the curable elastomeric material is applied against a wall that covers the front of the teeth and/or against a back wall that covers the lingual surfaces of the teeth. The barrier layer having the curable elastomer is then inserted into the mouth to form an impression of the teeth while the elastomeric material is sufficiently uncured or undercured such that it is readily deformable without causing the curable elastomeric material to fracture or tear. The curable elastomeric material is then allowed to at least partially cure so as to precisely contour with the shape of the teeth and form an impression layer.

In the case of a chemical cure elastomeric material, the material is typically a multi-part material (e.g., two-part material) that is prepared just prior to introducing it into the barrier layer. Once a impression layer is made, such materials will simply cure on their own at room temperature. Accordingly, the barrier layer and curing elastomer is left in the mouth in order for the curable elastomer to at least partially cure. It is advantageous to allow sufficient curing in order to prevent unwanted deformation of the impression layer while removing the dental tray from the mouth. Nevertheless, it will be appreciated that the method is not limited to any particular curing regimen.

In the case of a photo or thermally-cured elastomeric material, it may be necessary to remove the barrier layer and curable elastomer from the mouth, and then shine light onto or heat the material in order to promote polymerization and/or cross linking of the elastomeric material.

The curable elastomeric material is introduced directly onto the barrier layer, or onto a dental adhesive material that can be applied to the barrier layer before introducing the curable elastomeric material onto the barrier layer in order to increase the bond with the elastomeric material. Excess elastomeric material (e.g., flashing) can be trimmed away from the barrier layer as desired in order to increase comfort and/or improve the fit in the mouth and/or against the teeth.

Alternatively, a customized dental tray in accordance with the present invention can be prepared by a dentist or other dental professional. As such, the dental tray can be prepared by first making an impression of the teeth of a patient and then preparing the impression layer on the barrier layer as described herein except that the process is performed outside of the mouth.

### IV. Method of Use

The dental treatment trays of the present invention can be used as any dental treatment tray can be used as is well known in the dental arts. This includes the use of a dental treatment composition that is applied to the teeth receiving surfaces of the cured elastomer such that the dental treatment composition can be applied to the teeth. After the dental treatment composition is applied to the cured elastomer, the dental treatment tray is inserted into the mouth and fit onto the teeth. The dental treatment tray is worn for a sufficient time to perform a dental treatment.

In one embodiment, the dental treatment tray is used with the barrier layer (e.g., barrier tray and/or barrier liner) retaining the cured elastomer such that the cured elastomer functions as an impression layer. In another embodiment, an exoskeleton support tray is removed from the liner and cured elastomer such that the liner and cured elastomer functions as a dental treatment tray.

The dental treatment trays described herein can be worn for as little as a few minutes and as long as several hours. By way of example, not limitation, a typical bleaching session of fast duration may last from about 10 to about 30 minutes. A bleaching session of intermediate duration may last from about 30 minutes to about 2 hours. A bleaching session of long duration, including professional bleaching or overnight bleaching while a person is sleeping, may last from about 2 hours to about 12 hours.

Bleaching sessions may be repeated as many times as are needed to obtain a desired degree of whitening. In some cases, a clinical whitening effect has been observed after only 1-3 whitening sessions. A typical bleaching regimen will preferably include 1-20 bleaching sessions, more preferably 2-15 bleaching sessions, and most preferably 3-10 bleaching sessions. As such, the dental treatment tray of the present invention can be used for multiple bleaching sessions.

To remove the dental treatment tray, a person can pry open a corner of the barrier tray using a fingernail or rigid tool and then pull the remainder off. Any residual elastomer that remains adhered to the person's teeth can be removed by washing or flushing water over the person's teeth, and/or by brushing. Although the elastomers are very adhesive to teeth when protected from excessive moisture, they can be formulated to quickly breakdown and dissolve when flushed with excess water and/or by gentle mechanical action (e.g., brushing). This can include the removal of the dental treatment tray that includes the barrier tray holding the impression layer, or the barrier liner holding the impression layer.

### V. Kits

In one embodiment, the present invention includes kits that can be utilized in preparing the self-customizable dental treatment trays described herein. Kits within the scope of the invention may include at least one curable elastomeric material and at least one barrier tray. Also, the kits can include an exoskeleton support tray that has a liner disposed thereon. Optionally, the kit can include other desired components.

In one embodiment, a kit for preparing the self-customizable dental treatment trays include a plurality of compositions that are to be mixed in order to prepare the curable elastomer that forms the impression layer. This can include the polymerizable material and a curing agent being provided separate in the kit.

In one embodiment, the kit includes a flavoring composition to provide a flavor to the curable elastomer. Flavorings are well known in the art.

In one embodiment, the kit includes a therapeutic composition that is to be used with the customized dental treatment tray. Dental compositions that provide therapeutic benefits to teeth are well known and can be included with the kits of the present invention. Examples include bleaching agents, fluoride, desensitizing agents, remineralizing agents, antimicrobial agents, antiplaque agents, anti-tartar agents, anticariogenic agents, or other dental agents or medicines.

A common dental bleaching agent that is known to bleach teeth and that has been found to be safe for oral use is hydrogen peroxide. However, hydrogen peroxide does not itself exist free in nature, but only as an aqueous solution or as a complex. Preferred dental bleaching agents comprise complexes of hydrogen peroxide because they are more stable than aqueous hydrogen peroxide, which tends to be unstable when heated, especially when water is removed by evaporation.

Non-limiting examples of complexed hydrogen peroxide include carbamide peroxide and metal perborates. Other bleaching agents that can be used to bleach teeth include, but are not limited to, metal percarbonates, peroxides, chlorites, and hypochlorites, peroxy acids, and peroxy acid salts.

If present, the one or more bleaching agents are preferably included in an amount in a range of about 5% to about 80% by weight of the therapeutic composition, more preferably in a range of about 10% to about 60% by weight of the therapeutic composition, and most preferably in a range of about 20% to about 50% by weight of the therapeutic composition.

Examples of desensitizing agents include potassium nitrate, other potassium salts, citric acid, citrates, and sodium fluoride. Examples of remineralizing agents include sodium fluoride, stannous fluoride, sodium monofluorophosphate, and other fluoride salts. Examples of antimicrobial agents include chlorhexidine, triclosan, and tetracycline. Examples of antiplaque and anti-tartar agents include pyrophosphate salts.

The kit may include other components as desired to yield a final composition having desired properties. Examples of other components include, but are not limited to, plasticizers and humectants (e.g., glycerin, sorbitol, and polyethylene glycol), volatile solvents (e.g., water and alcohols, such as ethanol), bleaching agent stabilizers (e.g., EDTA and alkyl sulfates), bleaching agent activators (e.g., metals and metal compounds) neutralizing agents (e.g., sodium hydroxide), thickening agents (e.g., fumed silica), flavorants, sweeteners, and the like.

FIGS. 7A-7B illustrate embodiments of a kit 700a-b in accordance with the present invention. As shown, the kits 700a-b can be configured to protect the dental treatment tray 702 from contaminants during storage and prior to use, the tray-shaped dental treatment tray 702 can be packaged within a sealed container or package. As illustrated in FIG. 7A, the dental treatment tray 702 is sealed within a protective package 716 that includes a rigid support layer 718 and a peelable cover 720. When it is desired to use the dental treatment tray 702, the peelable cover 720 is removed and the dental treatment tray 702 is removed or separated from the support layer 718. In addition to, or instead of, the protective package 716, the dental treatment tray 702 may alternatively include a removable protective layer (not shown) that is temporarily placed adjacent to the interior surface 701 of the dental treatment tray 702. When it is desired to use the dental treatment tray 702, the removable protective layer is removed so as to expose the interior surface 701 so that the elastomer liner can be applied thereto.

FIG. 7B illustrates a kit 700b substantially the same as the kit 700a of FIG. 7A. Additionally, the kit 700b can include a container 730 that contains at least one component of the curable elastomer composition. Also, the kit 700b can include a tube 732 that contains at least one component of the curable elastomer composition. Furthermore, the kit 700b can include a tool 734 (e.g., brush, syringe, stirring wand, etc.) that can be used to mix the compositions contained in the container 730 and tube 732, or can be used to apply the curable elastomer composition to the interior surface 701 of the dental treatment tray 702.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A self-customizable dental treatment tray that is usable in a dental treatment for a person, the dental treatment tray comprising:
a barrier layer comprised of a soft, flexible polymer tray or sheet having a wall thickness of less than about 1 mm, said barrier layer having a impression-receiving portion; and
a customized impression layer disposed on the impression-receiving portion of the barrier layer and having a wall thickness of less than about 1 mm, said impression layer being comprised of an elastomer cured in the mouth of the person so as to form a teeth-receiving portion of the impression layer having contours adapted to conform with the shape the of the teeth of the person, the treatment tray having a wall thickness of less than 2 mm.

2. A dental treatment tray as in claim 1, wherein the barrier layer is an elastomeric barrier tray selected from the group consisting of a non-custom barrier tray, a thermally deformable barrier tray, or a custom-fitted barrier tray, said barrier tray having sufficient flexibility, adaptability, and/or compressibility so as fit comfortably within the mouth of the person and having substantially more rigidity than the impression layer.

3. A dental treatment tray as in claim 1, wherein the impression-receiving portion of the barrier layer is substantially devoid of contours adapted to conform with the shape of the teeth of the person.

4. A dental treatment tray as in claim 1, wherein the barrier layer is a flimsy liner which is disposed on a support tray and having a shape that conforms with the shape of the support tray such that the impression layer also has a shape that conforms with the shape of the support tray.

5. A dental treatment tray as in claim 1, wherein the barrier layer is a barrier liner, said barrier liner being flimsy and being held in a shape that conforms with the shape of the impression layer, said impression layer having sufficient flexibility, adaptability, and/or compressibility so as fit comfortably within the mouth of the person and having substantially more rigidity than the barrier liner.

6. A dental treatment tray as in claim 1, wherein the dental treatment tray is substantially devoid of a shape and dimension sufficient to function as a protective mouth guard that protects the teeth.

7. A dental treatment tray as in claim 1, wherein the customized impression layer is prepared by placing a curable elastomeric material onto the impression-receiving portion and curing said curable elastomeric material so as to form the teeth-receiving portion of the impression layer, wherein the curable elastomeric material is initially flowable when placed onto impression-receiving surface.

8. A dental treatment tray as in claim 7, wherein the curable elastomeric material and/or the barrier layer comprises at least one silicone-based polymer.

9. A dental treatment tray as in claim 9, wherein the silicone-based polymer comprises at least one polysiloxane.

10. A dental treatment tray as in claim 1, wherein at least one of the barrier layer or impression layer has a wall thickness of less than or about 0.3 mm.

11. A kit for use in preparing a self-customizable dental treatment tray that is usable in a dental treatment for a person, said kit comprising:
a barrier layer having a wall thickness of less than or about 1 mm, said barrier layer being a barrier tray or a barrier liner having a shape of a dental tray and an impression-receiving portion; and
at least one curable elastomeric material that is to be placed onto the impression-receiving portion so as to form a customized impression layer that has contours adapted to conform with the shape of the teeth of the person, said customized impression layer having a wall thickness of less than or about 1 mm.

12. A kit at in claim 11, wherein the barrier layer is the barrier liner, said barrier liner being disposed on a exoskeleton support tray and having a shape that conforms with the shape of the support tray, wherein the liner is peelable from the support tray after the impression layer is formed on the impression-receiving portion of the liner.

13. A method for making a self-customizable dental treatment tray that is usable in a dental treatment for a person, said method comprising:
providing a dental tray having a barrier layer with a wall thickness of less than or about 1 mm, said barrier layer being a barrier tray or a barrier liner having a shape of a dental tray and an impression-receiving portion;
introducing a quantity of a curable elastomeric material onto the impression-receiving portion;
placing the tray having the curable elastomeric material onto the teeth of the person in a manner so that the curable elastomeric material forms an impression layer; and
allowing the curable elastomeric material to at least partially cure on the teeth so as to form the impression layer having a teeth-receiving surface with contours adapted to conform with the shape the of teeth of the person, said impression layer having a wall thickness of less than or about 1 mm.

14. A method as in claim 13, further comprising:
removing the tray having the curing elastomeric material from the mouth of the person after the curing elastomeric material has formed the impression layer but before being fully cured; and
allowing the curing elastomeric material to continue curing outside the mouth of the person.

15. A method as in claim 13, further comprising preparing the barrier layer into an elastomeric barrier tray so as to have sufficient flexibility, adaptability, and/or compressibility so as to fit comfortably within the mouth of the patient and to have substantially more rigidity than the cured impression layer so as to provide structural support to the impression layer.

16. A method as in claim 15, further comprising preparing the impression-receiving surface of the barrier layer to be substantially devoid of contours adapted to conform with the shape of the teeth of the patent.

17. A method as in claim 13, further comprising shaping at least a portion of the tray to be substantially U-shaped, V-shaped, W-shaped, and/or L-shaped.

18. A method as in claim 13, further comprising configuring the dental treatment tray to be substantially devoid of a shape and dimension sufficient to function as a protective mouth guard that protects the teeth during athletic events.

19. A method as in claim 13, further comprising preparing the barrier layer into a flimsy liner, said liner being disposed on an exoskeleton support tray and having a shape that conforms with the shape of the support tray.

20. A method as in claim 19, further comprising separating the support tray from the liner after the impression layer is sufficiently cured such that the liner is held in the shape that conforms with the shape of the support tray by the impression layer.

21. A method as in claim 20, said impression layer having sufficient flexibility, adaptability, and/or compressibility so as fit comfortably within the mouth of the person and having substantially more rigidity than the liner.

22. A method as in claim 13, wherein the curable elastomeric material and/or the barrier tray comprises at least one silicone-based polymer.

23. A method as in claim 22, wherein the silicone-based polymer comprises at least one polysiloxane.

24. A method tray as in claim 13, further comprising preparing at least one of the barrier layer or impression layer to have a wall thickness of less than or about 0.3 mm.

25. A method as in claim 13, further comprising preparing the curable elastomeric material from multiple compositions that include at least one pre-elastomeric composition and a curing agent.
